(19) United States
(12) Patent Application Publication
(10) Pub. No.: US 2008/0052278 A1
(43) Pub. Date: Feb. 28, 2008

(54) SYSTEM AND METHOD FOR MODELING VALUE OF AN ON-LINE ADVERTISEMENT CAMPAIGN

(75) Inventors: Dema Zlotin, La Jolla, CA (US); Curt Nelson, Julian, CA (US); Brian Bartell, San Diego, CA (US); Russ Mann, Temecula, CA (US); Leif Andrew Heikkila, San Diego, CA (US)

Correspondence Address: COOLEY GODWARD KRONISH LLP;ATTN: Patent Group, Suite 1100, 777 - 6th Street, NW, WASHINGTON, DC, 20001, US

(73) Assignee: SEMDirector, Inc., San Diego, CA (US)

(21) Appl. No.: 11/758,592

(22) Filed: Jun. 5, 2007

Related U.S. Application Data
(60) Provisional application No. 60/823,615, filed on Aug. 25, 2006.

(51) Int. Cl. G06F 7/06

(52) U.S. Cl. 707/3; 707/E17.014

(57) ABSTRACT

A system and method, in the context of a search engine marketing campaign, for determining a value to be placed upon at least one mode through which an Internet user is referred to or otherwise enters a website of interest is described. Several embodiments include systems and methods for valuing at least one referral mode based on data acquired from one or more search engines and/or web analytics tools. The systems and methods are further configured to perform fraud analysis, achieve a predictive value of a referral mode and/or optimize the placement of a website in organic or paid search results at one or more search engines based on the value of the at least one referral mode.

### PRIORITY

The present application claims priority under 35 U.S.C. 119(e) to U.S. provisional application No. 60/823,615 entitled “System and Method for Modeling Value of an On-Line Advertisement Campaign,” filed on Aug. 25, 2006.

### CROSS-REFERENCE TO RELATED APPLICATIONS

This application relates to and incorporates by reference Provisional Application No. 60/778,594, entitled “System and Method for Managing Network-Based Advertising Conducted by Channel Partners of an Enterprise,” filed on Mar. 1, 2006, Provisional Application No. 60/823,615, entitled, “System and Method for Aggregating Online Advertising Data and Providing Advertiser Services,” filed on Aug. 25, 2006, Provisional Application No. 60/868,705, entitled “System and Method for Measuring the Effectiveness of an Online Advertisement Campaign,” filed on Dec. 5, 2006, Provisional Application No. 60/868,702, entitled “Centralized Web-Based Software Solution for Search Engine Optimization,” filed on Dec. 5, 2006.

### FIELD OF THE INVENTION

The invention relates to software for modeling or otherwise determining a value of an online marketing campaign which may include a search engine marketing campaign and/or a search engine optimization campaign. In particular, but not by way of limitation, aspects of the invention relate to modeling the value of a keyword in a search engine marketing campaign and/or a search engine optimization campaign.

### BACKGROUND OF THE INVENTION

With the growth of search engines, more and more companies are dedicating larger portions of their marketing budgets to search engine marketing (“SEM”) campaigns consisting of search engine optimization (“SEO”) initiatives and/or search engine advertising (“SEA”) campaigns. Many search engine optimization (SEO) initiatives are driven to obtain improved “organic” search listings. In this regard, the organic listing of a website pertains to the relative ranking of that site in the algorithmic results generated by a particular search engine on the basis of particular keyword searches. This contrasts with sponsored search applications/paid search results which are often listed proximate such organic search results and which identify sites that have compensated the operator of the search engine for such listing. For various strategic reasons, a company may drive the content of its site such that the site is ranked more prominently in the organic search results generated by one or more search engines.

Advertisers contracting for placement within the results generated by sponsored search applications may be required to pay for each click-through referral generated through such sponsored search results. Placement within the results is generally determined in accordance with a competitive bidding process, pursuant to which advertisers select and bid upon those search keywords perceived to be most pertinent to the products or services offered through their website. Those advertisers bidding higher for particular keywords are generally placed correspondingly “higher” or otherwise more favorably in the sponsored search results corresponding to such keywords. Although such SEA campaigns have benefited the advertisers, inefficiencies have arisen, making it beneficial for advertisers to qualitatively and quantitatively analyze return on investment pertaining to the click-through referral generated via the sponsored search results.

Operators of websites may also pay high consultation fees for SEO campaigns wherein a consultant analyzes an operator's website and makes recommendations to enhance the website's ranking in an organic listing of a search engine.

Unfortunately, previous systems, methods and computer readable instructions for conducting such analysis are inadequate with respect to valuing keywords based on the specific needs of particular advertisers in SEA and SEO campaigns. For example, the previous systems are incapable of applying varying metrics that are unique to each advertiser in order to determine a keyword value that is based on the specific needs of each advertiser. Moreover, previous systems do not offer interactive client selection and weighting of specific website performance indicators for subsequent trending and graphing of keyword value pertaining to those specific indicators. Moreover, previous systems do not optimize keyword value based on frequently changing weights of multiple performance indicators.

### SUMMARY OF THE INVENTION

Exemplary embodiments of the invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The invention generally relates to a system and method for determining, in the context of a search engine marketing campaign, or a value to be placed upon at least one mode through which an Internet user is referred to or otherwise enters a website of interest. In certain embodiments, the system and method acquires data associated with each such “referral mode,” and analyzes the data to achieve a value of the referral mode with respect to a website. In one particular embodiment, the system and method compares the value of the referral mode with a threshold value to reach a determination, and modifies one or more parameters associated with the website (e.g., a paid search bid amount, a use of a keyword within the website) in response to the determination in order to optimize the placement of the website in organic or paid search results. In another particular embodiment, the system and method weighs the data associated with the referral mode, sums the weighted data to achieve a gross profit value of the referral mode, and subtracts a cost associated with the referral mode to determine the value of the referral mode. In yet another particular embodiment, the system and method perform fraud analysis based on the data. Alternatively, in another particular embodiment, the system and method achieve a predictive value of the referral mode based on the data.

### BRIEF DESCRIPTION OF THE DRAWINGS

Various objects and advantages and a more complete understanding of the invention are apparent and more readily appreciated by reference to the following Detailed Description and to the appended claims when taken in conjunction with the accompanying Drawings wherein:

FIG. 1 is a block diagram depicting a system for modeling value of keywords in an online advertising campaign;

FIG. 2 is a flowchart detailing a value analysis process performed by the system for modeling value of keywords in an online advertising campaign; and

FIG. 3 is an example of an interface for selecting performance indicators and associated weighted values;

FIG. 4 is a flowchart detailing a value analysis process performed by the system for generating value models based on the normalized master data set;

FIG. 5 illustrates keyword value displays used in accordance with embodiments of the invention to optimize a online marketing campaign; and

FIG. 6 is a block diagram of an alternative client computing system for carrying out the invention.

### DETAILED DESCRIPTION

The invention generally relates to a system and method for modeling and/or optimizing, in the context of a search engine marketing (“SEM”) campaign, the value of one or more referral modes through which an Internet user is referred to or otherwise enters a particular website. The SEM campaign may, for example, comprise a search engine optimization (“SEO”) initiative and/or a search engine advertising (“SEA”) campaign (e.g., a pay-per-click and paid inclusion campaign). Embodiments of the invention permit advertising entities to assess the value of specific referral modes based on reconfigurable metrics and flexible, relative weightings of each metric.

As used herein, “value” pertains to any measurable commercial value pertaining to one or more referral modes.

As used herein, “referral mode(s),” “mode(s) of referral” or any variation thereof pertain, directly or indirectly, to the mode(s) or process(es) through which an Internet user enters or uses a website or webpage of interest. For example, a referral mode may comprise a particular keyword entered by an Internet user into a search engine. Upon entry of the keyword, the search engine displays organic search results and/or a paid search results that may list the webpage of interest. The user may then click on a web link associated with the webpage to enter or use the webpage. Thus, since the keyword is at least indirectly associated with the user's entry into the webpage, the value of the keyword (as a referral mode) can be determined.

In addition to a keyword, referral modes may comprise inbound links from other websites (other than search engines) and/or Internet-based advertisements (“ads”), including, e.g., text, image, video, and audio ads. In relation to an Internet-based ad, a user clicks on the ad, the user is connected to the website of interest and subsequently takes actions that result in measurable value. Thus, the Internet-based ad or the inbound link is at least one reason explaining why the user enters the webpage of interest.

Alternatively, referral modes may be described as actions taken by one or more Internet users in association with content offered at the webpage. For example, the action may include downloading or viewing content (e.g., text, image, video or audio). One of skill in the art will appreciate that a certain actions taken in association with content may directly or indirectly correspond to modes through which a webpage is entered and can thus be valued as referral modes.

Referral modes may also be described as a media ad viewings by Internet users prior to entering the webpage of interest. For example, the media ad may include text, image, video or audio ads available via the Internet, print media, and/or broadcast media, among others. The existence of a media ad viewing by a user may be determined via any number of methods within both the scope and spirit of the invention, including, e.g., an online survey-style entry by the user at the webpage of interest.

Referral modes may also be described as geographic, demographic, and/or temporal targeting of users prior to the users entering the webpage. Geographic, demographic and temporal targeting may be accomplished via any number of methods (e.g., delivering or making available particular media ads to particular geographic locations or particular demographics at particular times, delivering web links associated with the webpage of interest via email or screen pops, etc.). Geographic targeting may be based on a geographic area associated with the users. For example, the geographic area may be determined by a zip code, a city, a state, or a county associated with the users. Demographic targeting may be based on any number of categories, including, e.g., age, gender, race, or shopping history/preferences of users. Temporal targeting may be accomplished during a particular time period (e.g., during particular hours, days, weeks, months, years, etc.). By way of example, the existence of geographic, demographic or temporal targeting may be determined via any number of methods within both the scope and spirit of the invention, including, e.g., an online survey-style entry by the user at the webpage of interest.

Alternatively, by way of another example, the existence of geographic, demographic or temporal targeting may be determined in relation to a user clicking on an Internet-based ad. In one embodiment, data associated with the Internet-based ad may be stored, including data relating to the day the user clicked on the ad, the type of ad that was selected by the user, a keyword associated with the ad (if applicable), a geographical area to which the ad was targeted, and demographic information about the user that is available via any application capable of collecting information about the user.

For sake of clarity or presentation, embodiments of the invention described herein are directed to the valuation of referral modes in the form of keywords; however, one of skill in the art will appreciate alternative embodiments may be concerned with valuing referral modes other than keywords.

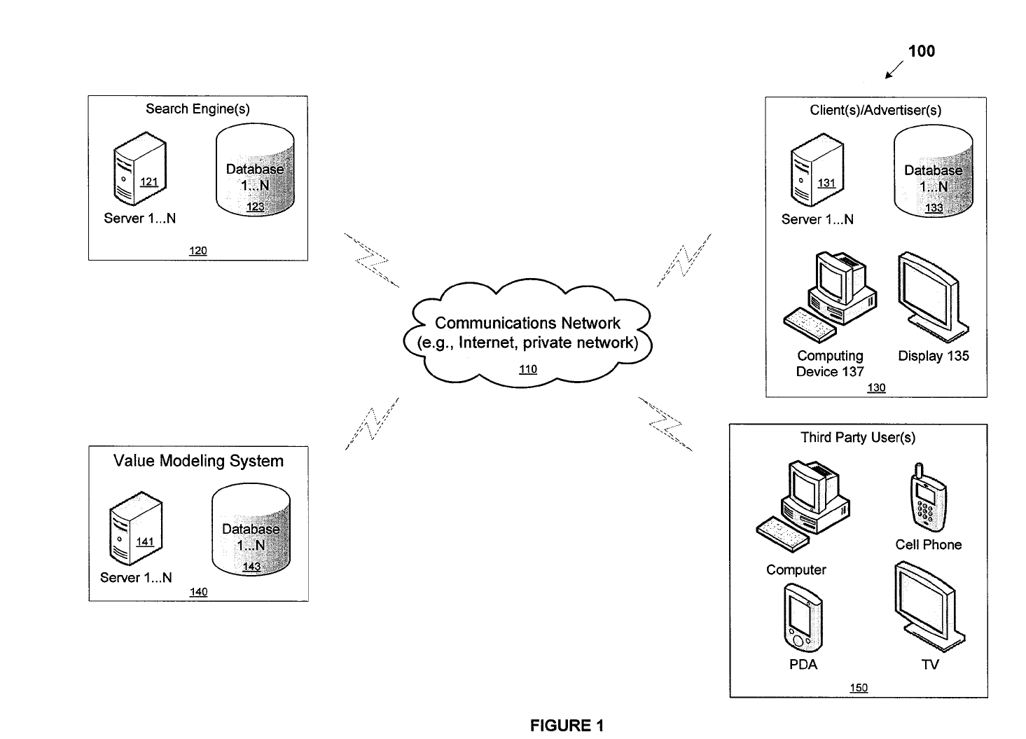

Aspects of the invention are designed to operate on computer systems, servers, and/or other like devices. While the details of the embodiments of the invention may vary and still be within the scope of the claimed invention, FIG. 1 shows a block diagram depicting a typical network system 100 for modeling value of keywords in an online marketing campaign in accordance with the invention. The network system 100 is only one example of a suitable computing environment and is not intended to suggest any limitation as to the scope of use or functionality of the invention. Neither should the network system 100 be interpreted as having any dependency or requirement relating to any one or combination of components illustrated in the exemplary network system 100.

Aspects of the invention may be described in the general context of computer-executable instructions, such as program modules, being executed by a computer or server. Generally, program modules include routines, programs, objects, components, data structures, and the like that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

As is shown, the network system 100 includes a communications network 110, such as the Internet or a private network, capable of providing communication between devices at search engine(s) 120, advertiser/client(s) 130, value modeling system 140, and third party user(s) 150 described hereinafter. The devices of FIG. 1 communicate with each other via any number of methods known in the art, including wired and wireless communication pathways.

As shown in FIG. 1, a search engine 120 is accessible by a third party user 150, a client 130, and by the value modeling system 140. The third party user 150 may utilize any number of computing devices that are configured to retrieve information from the World Wide Web (“WWW”), such as a computer, a personal digital assistant (PDA), a cell phone, a television (TV). The client 130 is typically a business entity with one or more online marketing campaigns associated with the search engine 120. The value modeling system 140 operates one or more servers 141 capable of Internet-based communication with the search engine 120 and the client 130. As is discussed below, the value modeling system 140 enables the client 130 to perform valuation of one or more keywords that exist in online marketing campaigns of the client 130. The value modeling system 140 further enables the client 130 to view models relating to the value of keywords. It is a feature of embodiments of the invention that these models enable the client 130 to quickly identify marketing inefficiencies and/or opportunities.

As those skilled in the art will appreciate, various intermediary network routing and other elements between the communication network 110 and the devices depicted in FIG. 1 have been omitted for the sake of simplicity. Such intermediary elements may include, for example, the public-switched telephone network (PSTN), gateways or other server devices, and other network infrastructure provided by Internet service providers (ISPs).

Referring again to FIG. 1, each search engine 120 is typically comprised of at least one web server 121 and at least one database 123. The database 123 may be used in connection with the generation of web pages, rendered by a web browser (not shown) executed on a computing device of the third party user 150, that contain the results of searches requested by the third party user 150. The contents of the database 123 typically include, among other things, the results accumulated by one or more “spider” (or crawler) programs disposed to search the web and return content to the database 123 for subsequent storage and tracking. The database 123 may also include information pertaining to a pay-per-click (PPC) advertising service operated by the search engine 120.

Computing devices at each of the third party users 150 may execute the web browser through which search terms may be entered via a search page representation provided by a search engine 120. Upon receiving the search terms from the third party user 150, the search engine 120 typically returns a plurality of search results to the third party user 150. The returned search results generally include links to web pages hosted by the websites of various business entities (e.g., the clients 130), thereby enabling the third party user 150 to view information from these web pages through the web browser executing on the third party user device 150.

In the case of the third party user 150 that clicks on a web link listed at the search engine 120, the database 123 stores information pertaining to the click such as the date and time of the click, the cost of the click, and the client 130 with which the link is associated. Information pertaining to subsequent clicks, by other third party users 150, of the client's web link is added to the database 123, and is then typically available to the client 130 and/or the value modeling system 140 in a report downloadable from the search engine 120.

After a third party user 150 clicks on a web link associated with a client 130, the third party user 150 is connected to the client's website associated with the web link. Upon this connection, one or more web analytics tools operating on a website server 131 track the website activity (e.g., usage and behavior) associated with the third party user 150. For example, the web analytics tool may track the number of page views, registrations, e-commerce sales, telephone sales, downloaded documents, multimedia views, and other activities associated with the third party user 150. Information associated with the website activity of the third party user 150 may be stored in a database 133, and is typically available as a report to the client 130 and/or to the value modeling system 140.

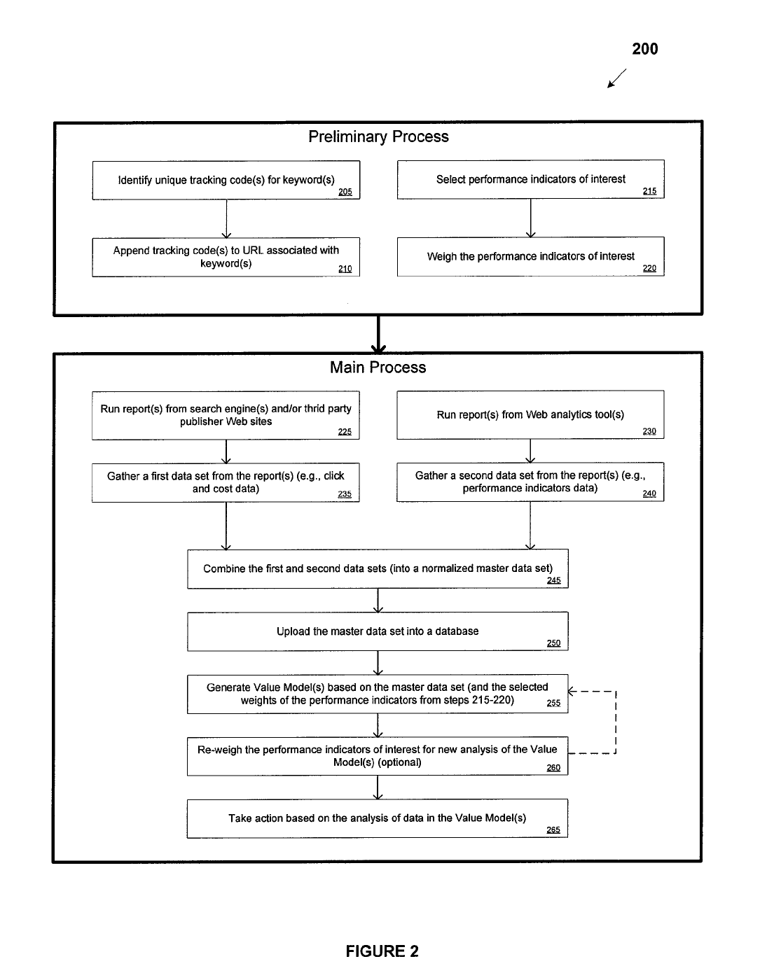

One aspect of the invention pertains to analyzing the effectiveness of a keyword purchase by a client 130 from a search engine 120. The measurement of effectiveness of a keyword purchase can, for example, be derived from any one of: a report from the search engine that includes, among other things, a listing of the purchased keyword and the number of “clicks” pertaining to the keyword for a given time period; a report from a web analytics tool that includes, among other things, a listing of the website activities associated with a third party user 150; and a combination of the search engine and web analytics tool reports. With respect to deriving the effectiveness of a keyword from a combination of the search engine and web analytics tool reports, the invention, as will be shown in the description of FIG. 2 below, is configured to match data in the search engine reports to associated data in the web analytics tool report.

Attention is now drawn to FIG. 2, which illustrates a flowchart detailing a value analysis process performed by the system 100 for modeling the value of keywords in an online advertising campaign. The process of FIG. 2 is configured to match data in the search engine reports to associated data in the web analytics tool reports so as to derive the effectiveness of a keyword from a combination of the search engine reports and the web analytics tool reports.

Referring to FIG. 2, the flowchart is segmented into two processes: 1) a preliminary process 201, and 2) a main process 202. During the preliminary process 201 the client 130 and/or the value modeling system 140 identifies a tracking code that will be added to a URL associated with the purchase of a keyword by the client 130 from the search engine 120 (step 205). As is known in the art, a web link has a URL associated with it that identifies the network location of the particular website associated with the web link. When the third party user 150 clicks on such a web link, the associated URL is used to find the location of the website to which the third party user 150 is subsequently connected.

After identifying the tracking code in step 205, the client 130 and/or the value modeling system 140 appends the identified tracking code to the URL associated with a the keyword purchase transacted between the search engine 120 and the client 130 (step 210). The tracking code is added to the URL provided by the client 130 to the search engine 120 at the time of, or after, the keyword transaction.

In one embodiment, the tracking code includes information pertaining to the search engine 120 from which the keyword was purchased, as well as an indication of the keyword. Additional information may include indications of an advertisement (“ad”) group to which the keyword belongs, the type of advertising network, and the section of the website of the client 130 to which the URL pertains. One aspect of the invention enables the client 130 to utilize this invention with no additional website code or HTML tagging beyond that which is already present as a result of the requirements of any web analytics tools operating on the website of the client 130.

As is also shown in FIG. 2 with respect to the preliminary process 201, the client 130 may select individual performance indicators (e.g., website activities of third party users 150) from which the client 130 can analyze the value of a keyword (step 215). Upon the selection of a given performance indicator, the client 130 may select an associated weight that may be used during the valuation of the keyword (step 220). The selected performance indicators and associated weighted values may be stored in the database 133 at the client 130 or at a database 143 at the value modeling system 140.

The weight is a value assumption placed on a given performance indicator by the client 130 to represent the value of that performance indicator with respect to the commercial operations of the client 130. The weight, for example, may be measured in currency (e.g., the US dollar), a rating system, and/or other measurement parameters. As will be described in further detail hereinafter, the performance indicators and their assigned weights may be used in conjunction with the search engine and web analytics tool reports to build a formula for assessing the value of a keyword.

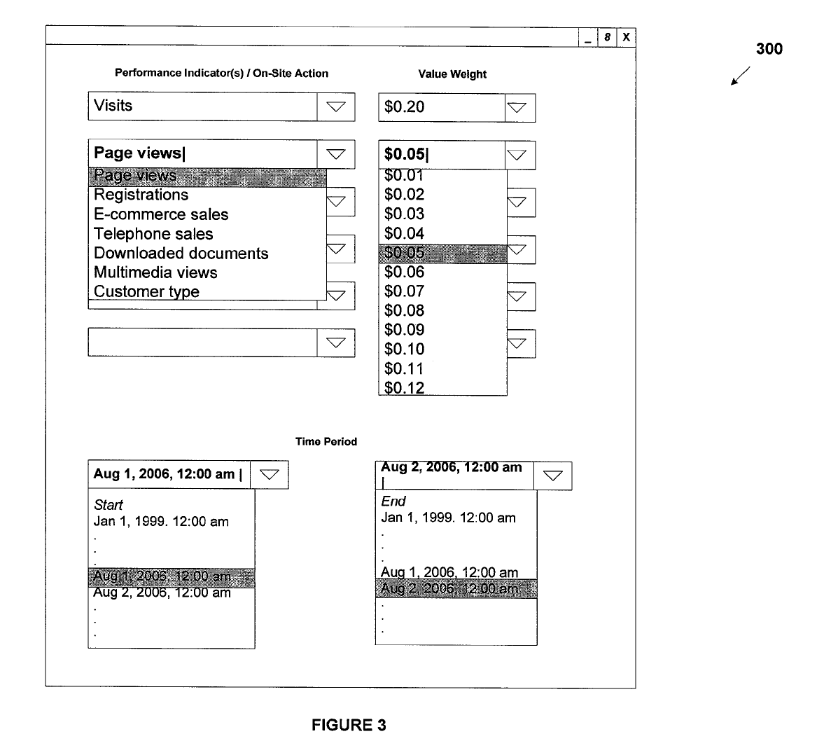

Attention is now drawn to FIG. 3, which shows an example of an interface 300 rendered by a client display 135 (FIG. 1) for selecting performance indicators and associated weighted values. As shown, the interface provides a plurality of drop down menus from which a user of a computing device 137 (FIG. 1) can select performance indicators (e.g., visits, page views, etc.) and associated weights (e.g., $0.20, $0.05, etc.). The interface 300 of FIG. 3 is also shown to provide a dropdown menu from which the user can select a time period within which the data in the search engine and web analytics tool reports may be analyzed.

In an exemplary embodiment, the interface 300 is provided to the computing device 137 of the client 130 by the value modeling system 140 via the communication network 110. In another embodiment, the interface is generated locally at the client 130.

Attention is now turned to the main process 202 shown in FIG. 2. As shown, search engine and web analytics tool reports are retrieved from the search engine 120 and the web analytics tool of the client 130 (steps 225, 230). One of skill in the art will appreciate that web analytics tools and search engines frequently diverge in their reporting of clicks of third party users 150 to the website and subsequent website usage. One aspect of the invention enables reconciliation and accounting of this discrepancy to provide a more accurate valuation of a keyword.

In steps 235 and 240, data is gathered from each of the search engine and web analytics tool reports, and then combined into a normalized master data set in step 245. Specifically, at step 245 the tracking codes identified and appended in steps 205-210 are used to match search engine data with associated web analytics data for SEA campaigns. For example, the tracking code “ppc_gg∥group|1|s” may represent the keyword “hairstyle” purchased from the search engine Google.

Data may be collected during a configurable instance of time, during a configurable period of time, or during configurable intervals of time. Additionally, collected data may be stored as historical data (e.g., in the database 143) and subsequently retrieved for comparison to collected data.

Once the master data set has been formed, it is stored at step 250 (e.g., in the database 143 at the value modeling system 140, or in the database 133 at the client 130). One of skill in the art will appreciate that more than one of the above steps may be omitted while staying within both the scope and spirit of the invention. For example, step 245 may not be required.

In an exemplary embodiment, steps 225-250 are performed by the value modeling system 140 via the communication network 110. In another embodiment, steps 225-250 are performed by the client 130. In yet another embodiment, steps 225-250 are performed by both the client 130 and the value modeling system 140.

Valuation of Keyword(s)

One aspect of the invention enables the client 130 to maximize return on investment (ROI) with respect to one or more keywords purchased from one or more search engines and/or one or more keywords pertaining to organic search results. Additional aspects may enable the client 130 to value keywords based on any number of metrics, including a cost per value point, a number of value points per visitor, a number of page views per visitor, a cost per page view, a cost per registration, a cost per download, a cost per video view, total cost, total revenue, total margin, a return on advertising spent (ROAS), margin per visitor, revenue per visitor, a cost per customer acquisition, a cost per click, and a click-through-rate.

Certain aspects of the invention allows the client 130 to effectively value its investment (i.e., a keyword purchase or a cost of optimizing a website to obtain a higher ranking in an Organic listing) based on parameters selected and weighted by the client 130. Another aspect of the invention enables the client 130 to identify unused or inefficient marketing strategies of which the client 130 may not be aware. Such strategies may be based on, for example, historical data, competitor bidding data and/or other data pertinent to identifying such strategies.

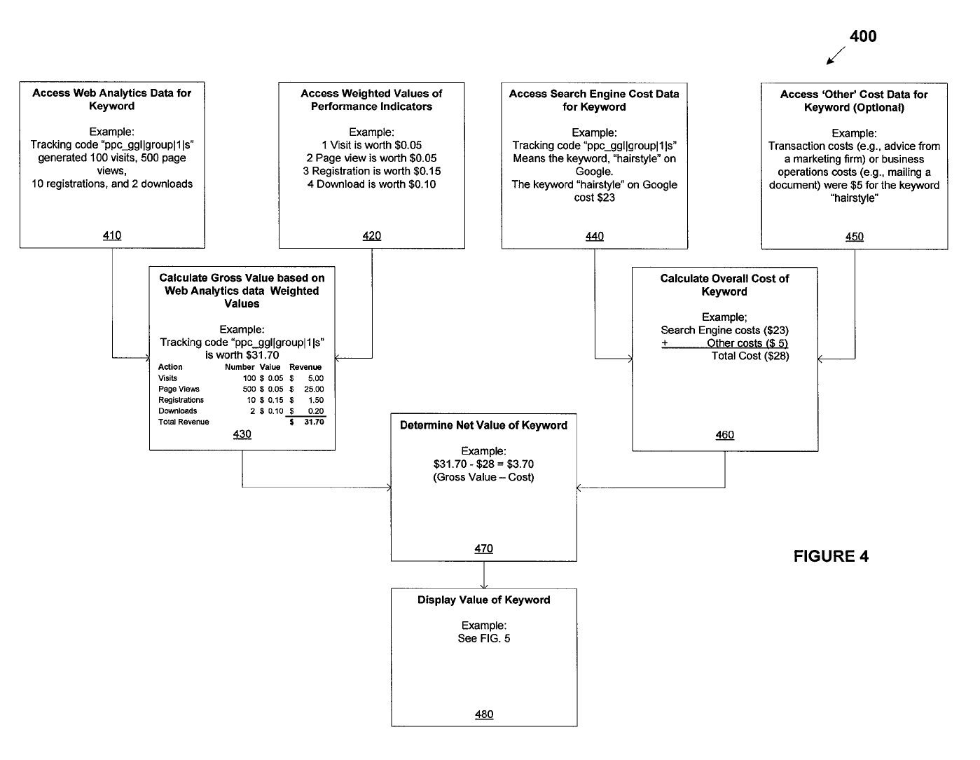

As shown in step 255 of FIG. 2, one or more configurable value model(s) of a keyword are developed based on the master data set and the weighted performance indicators selected in steps 215-220. By way of example, FIG. 4 depicts a flowchart 400 detailing a process for generating a “value model;” that is a model for representing the value of one or more keywords with respect to, for example, one or more other keywords, historical values of the one or more keywords, business costs associated with the one or more keywords, and/or business metrics associated with the one or more keywords, among others. One of skill in the art will appreciate alternative configurations to the one described below, including configurations in which some of the steps are rearranged and/or removed.

As shown in FIG. 4, the value modeling system 140 accesses web analytics data pertaining to a keyword of interest (step 410). At step 420, the value modeling system 140 accesses data related to the weighted performance indicators selected in steps 215-220, and then, at step 430, the gross value of the keyword of interest is calculated based on the web analytics data and the weighted performance indicators.

In one embodiment, calculation of the gross keyword value is performed by multiplying (i) the weights of each of the performance indicators selected in steps 215-220 and (ii) respective web analytics data pertaining to those selected performance indicators. For example, if the client 130, during steps 215-220, selected ‘registrations’ to have a weight of $0.50, then the total number of registrations associated with the keyword of interest, as determined by the web analytics data, is multiplied by $0.50. The result is the gross value of the keyword with respect to registrations. During step 430, calculations similar to the one described in the example above are performed with respect to every performance indicator that was selected in step 215. Additionally, calculations may be performed on a per-third-party-user-basis or a per-visit-basis. Each gross value of these calculations is then summed and the resulting value corresponds to the gross total value of the keyword with respect to the performance indicators of importance to the client 130. As a result, total revenue associated with a visit to a website by third party user 150 occurring as a consequence of clicking a keyword advertisement at a search engine can be calculated as the sum of individual revenues associated with individual performance indicators selected by the client 130.

Additional revenue streams may also be calculated at step 430. For example, the client 130 may be content-focused rather than commerce-focused. A content-focused client 130 generates revenue by selling advertising on its website. Many content-focused clients 130 use the ‘revenue per 1000’ model, where advertisers on the client's website pay a set fee for every 1000 views of a webpage that includes their advertisement. The total revenue for each page view associated with the advertisement is calculated by dividing 1000 into the fees paid by a specific advertiser for a specific advertisement.

Either before, after or during steps 410-430, the value modeling system 140 accesses search engine data pertaining to the keyword of interest (step 440). The accessed search engine data may include, among other data, the cost of the keyword of interest for the time period in which the keyword value is being analyzed. At optional step 450, other cost data associated with the keyword is accessed. For example, the other cost data may include various business expenses associated with billed hours, resources used, transaction costs, and research and development costs attributable to the keyword. At step 460, the overall cost is calculated by adding the costs determined in steps 440-450.

Once the keyword value and keyword cost are determined, the value modeling system 140 determines the net/margin value of the keyword of interest (step 470). In one embodiment, the net keyword value is determined by subtracting the keyword cost from the gross keyword value. The result may then be used to create one or more static and/or interactive media displays (step 480) that may be charted for the client 130 as a function of time, search engine, and other discriminators, to provide a variety of actionable views for the client 130 to pursue optimizations of their search engine marketing strategy.

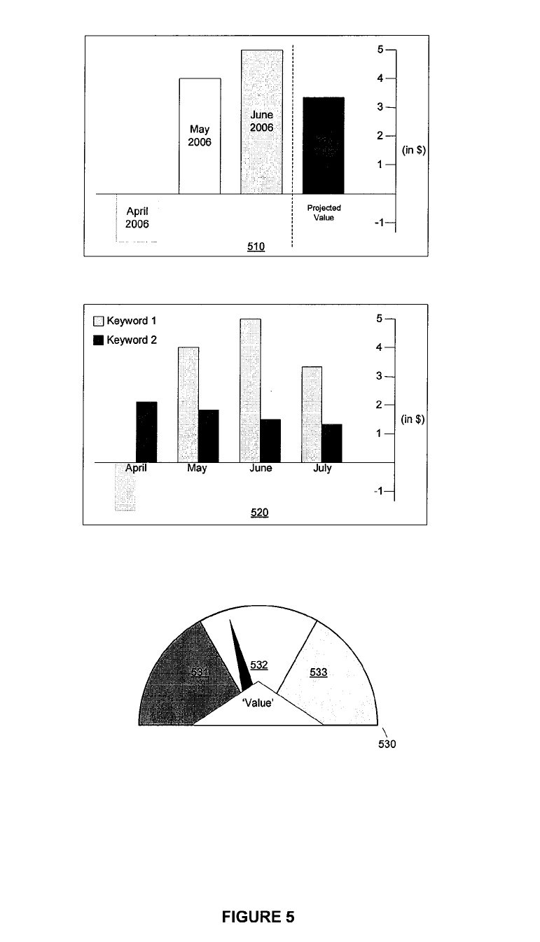

One aspect of the invention enables trending and graphing of individual keywords, search engines, campaigns, or other grouping techniques to compare relative performance and identify areas of optimization and performance improvement. For example, as shown in FIG. 5, the value of the keyword may be presented in a bar graph 510, and compared to historical and/or projected data. Alternatively, the keyword value may be compared to other keyword values, as is shown in bar graph 520. The keyword value may also be presented in a ‘meter’ diagram 530 that rates the value of the keyword based on any number of metrics, including predetermined thresholds 531-533 set by the client 130, historical values, and/or other keyword values.

At step 260, the client 130 may re-weigh the performance indicators selected in step 215 in order to analyze the value of a keyword using different weight parameters. The client 130 may also select and weigh a different group of performance indicators than those that were selected and weighed in steps 215-220. One advantage of step 260 is that it allows the client 130 to value the keyword based on different commercial metrics. The client is then enabled to compare and contrast different approaches to search engine marketing campaigns.

At any time the value modeling system 140 or the client 130 may take action based on the generated value models (step 265). For example, the value modeling system 140 may alert the client 130 (e.g., via email, a user interface, etc.) when the value of a keyword does or does not meet predetermined standards. The client 130 might choose to optimize its marketing campaign to reflect the assessed value of a keyword. A multitude of optimizations at the keyword and search engine level can be performed using the value of the keyword, such as lowering of a bid to increase keyword profitability, raising of a bid to capture additional clicks of the third party user 150, eliminating a keyword from a search engine to re-allocate budget to higher value keywords, or targeting a specific profit per keyword or search engine. Many variations, modifications and alternative optimizations can be performed using insight gained from the value model. Additionally, the value model system 140 may be configured to automatically adjust bids without requiring any manual input from the client 130.

For example, if the keyword value is negative or below a threshold value, or if a particular performance indicator is below a threshold value, the value modeling system 140 may recommend or automatically execute removal or lowering of a bid associated with the keyword at a particular search engine. Under some circumstances, the value modeling system 140 may recommend or automatically execute changing of the landing page associated with the URL of the web link at the search engine 120. Alternatively, if the keyword value is positive or above a threshold value, or if a specific performance indicator is above a threshold value, the value modeling system 140 may recommend or automatically execute increasing of a bid or the budget associated with the keyword. In some embodiments the value modeling system 140 may identify similar keywords and rotate them into the pay-per-click program of the client 130.

During a bid optimization process, the value modeling system 140 may compare a computed value of a particular keyword with values of that keyword for competitors of the client 130. In order to do so, the value modeling system 140 downloads bid landscape data from search engine application programming interfaces (APIs), including bid data pertaining to the competitors. The value modeling system 140 may also compare a computed value of a particular keyword with computed values of the same keyword based on higher or lower bid levels. Alternatively, the value modeling system 140 may compare a computed value of a particular keyword with historical values of the same keyword.

One aspect of the invention enables modeling and optimization based on frequently changing weights of multiple performance indicators in order to ensure such indications remain aligned with changing commercial needs. Any subset of these changing performance indicators can be used to establish the value of a keyword and build an appropriate value model for a specific time period. For example, cost rates for keyword advertisements, profit margins for items sold based on seasonal sales, lifetime value of customer or customer segments, and click-fraud rates at the various search engines or advertising networks may all change frequently. Embodiments of the invention are configured to enable these value assessments to be adjusted so as to reflect these dynamic changes.

In one embodiment of the invention, the value modeling system 140 performs fraud analysis to determine whether abuse exists within a sponsored search. For example, the value modeling system 140 may detect a spidering program that automatically selects (i.e., “clicks”) a website without visiting the website. In such a case, data pertaining to a number of visits to a website may be compared to the number of clicks associated with that website, and any disproportionate volumes of clicks when compared to number of visits may indicate fraud (e.g., 5000 clicks compared to 2500 visits). Alternatively, by way of example, the fraud analysis may use historical data (e.g., data collected in steps 235-240 of FIG. 2) to determine whether the behavior of a particular visitor differs from historical patterns of that visitor, a subset of visitors, or an average visitor. This approach may also be used to determine whether any recent alterations to a website may be causing differences in behavioral patterns of visitors from historical patterns.

At step 265, for example, the value modeling system 140 or the client 130 may turn off, lower or increase bids with respect to keywords and/or search engines having performance levels below or above predetermined thresholds. For example, a keyword at a poor performance level (e.g., a reported value in the bottom 20% of all keywords, or a reported value below a desired value) may be turned off or its bid may be drastically lowered. By way of another example, the bid level of a keyword with a good performance level may be adjusted to an optimal level, which may include setting the bid so as to obtain a maximum value (e.g., margin) with respect to the keyword. As the cost-per-click for a keyword increases, the reported value of the keyword decreases unless the additional cost-per-click is offset by increased revenue (or another type of value-based metric) generated via additional clicks.

Alternatively at step 265, the value modeling system 140 or the client 130 may examine advertisements and/or landing pages associated with keywords and/or search engines to perform a similar measurement of value for the keyword-advertising pair or the keyword-landing page pair.

One aspect of the invention pertains to predicting future value of a referral mode (e.g., a keyword). In accordance with one embodiment, a predictive future value of a keyword may be determined by analyzing historical values of the keyword (and in some cases, similar keywords). For example, a future value of the keyword may be achieved by trending the historical values (e.g., over time) and then assigning a future value in accordance with the trend (e.g., if the value of the keyword has a historical growth rate of 1%, the future value would be determined based on that growth rate).

In accordance with another embodiment, a predictive value of a keyword may be determined using a variety of historical/actual and/or estimated data. As one of skill in the art will appreciate, the following approach may be used to arrive at an actual value of a keyword, as opposed to predicted/estimated value of a keyword. For example, a number of searches made in association with a particular keyword at one or more search engines may be downloaded from the one or more search engines or may be calculated using historical data related to a number of searches. When calculating a number of searches for a particular search engine, a known number of searches for a second search engine may be multiplied by a ratio of the particular search engine's market share over the second search engine's market share. If, for example, Company A has a market share of 40% and Company B has a market share of 60%, an estimated number or searches for Company A will be achieved by multiplying a known number of searches for Company B by 40/60. Additionally, an estimated number of searches for a particular country may be calculated by multiplying an estimated or known number of searches in a second country numbers by the percentage of Internet users in the particular country with respect to Internet users in the second country.

The number of searches may be multiplied by a click through rate to determine a number of clicks associated with the keyword. The number of clicks may then be multiplied by cost-per-click data to arrive at a media ad cost associated with the keyword. A number of conversions may be determined by multiplying the number of clicks associated with the keyword by a conversion rate. A conversion may include various things, including a lead, a sale, a purchase, a content view, a content download, and a membership registration, among others. The conversion rate pertains to a percentage of visitors to a particular website who take a desired action. A cost-per-conversion may then be determined by dividing the media ad cost by the number of conversions. A cost-per-conversion describes the cost of acquiring a customer, typically calculated by dividing the total cost of an ad campaign by the number of conversions. One of skill in the art will appreciate that any of the variables (e.g., a number of searches, a conversion rate, etc.) used in the above analysis may be actual numbers or estimated numbers. One of skill in the art will also appreciate that averages of historical data, or desired portions of the historical data, may be used as one or more of the variables or may be used to calculate one or more of the variables in the above analysis.

One of skill in the art will also appreciate alternative embodiments to those described above that achieve a predicted value of a referral mode (e.g., a keyword).

Client Architecture

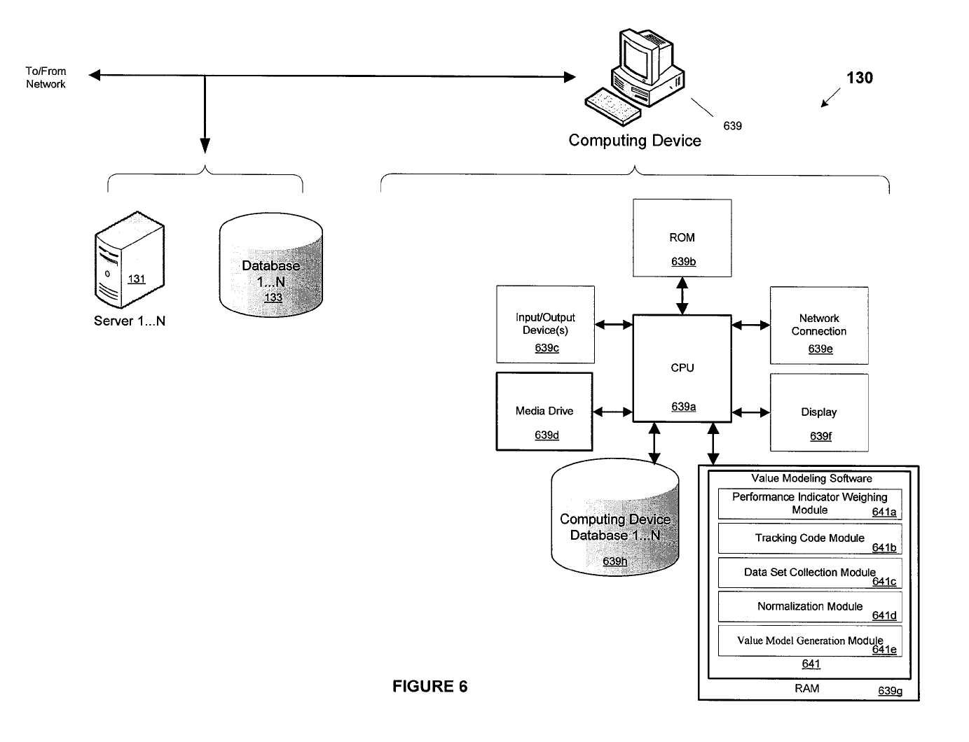

Attention is now drawn to FIG. 6, which depicts an exemplary implementation of the client 130. As is shown, the client 130 includes a server 131 connected to a database 133, both of which may communicate either directly or indirectly with the communication network 110. FIG. 6 also includes a computing device/system 639 configured in accordance with one implementation of the invention. The computing device 639 may include, but not by way of limitation, a personal computer (PC), a personal digital assistant (PDA), a cell phone, a television (TV), etc., or any other device configured to send/receive data to/from the communication network 110, such as consumer electronic devices and hand-held devices.

The implementation depicted in FIG. 6 includes a processor 639a coupled to ROM 639b, input/output devices 639c (e.g., a keyboard, mouse, etc.), a media drive 639d (e.g., a disk drive, USB port, etc.), a network connection 639e, a display 639f, a memory 639g (e.g., random access memory (RAM)), and a file storage device 639h.

The storage device 639h is described herein in several implementations as a hard disk drive for convenience, but this is certainly not required, and one of ordinary skill in the art will recognize that other storage media may be utilized without departing from the scope of the invention. In addition, one of ordinary skill in the art will recognize that the storage device 639h, which is depicted for convenience as a single storage device, may be realized by multiple (e.g., distributed) storage devices.

As shown, a value modeling software application 641 includes a performance indicator weighing module 641a, a tracking code module 641b, a data set collection module 641c, a normalization module 641d, and a value model generation module 641e, which are implemented in software and are executed from the memory 639g by the processor 639a. The software 641 can be configured to operate on personal computers (e.g., handheld, notebook or desktop), servers or any device capable of processing instructions embodied in executable code. Moreover, one of ordinary skill in the art will recognize that alternative embodiments, which implement one or more components in hardware, are well within the scope of the invention.

Each module 641a-e is associated with one or more of the steps described above with respect to FIG. 2. For example, the performance indicator weighing module 641a pertains to steps 215-220 and 260, the tracking code module 641b pertains to steps 205-210, the data set collection module 641c pertains to steps 225-240, the normalization module 641d pertains to steps 245-250, and the value model generation module 641e pertains to step 255.

### OTHER EMBODIMENTS

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims. For example, the exemplary systems and methods of the invention have been described above with respect to the value modeling system 140. One of skill in the art will appreciate alternative embodiments wherein the functions of the value modeling system 140 are performed on other devices in the networked system 100.

What is claimed is:

1. A method for determining a value of a referral mode relating to access of a website, said method comprising:
acquiring data associated with the referral mode; and
analyzing the data to determine a value of the referral mode with respect to the website.

2. The method of claim 1, wherein the referral mode corresponds to a keyword associated with organic or paid search results at a search engine.

3. The method of claim 1, wherein the referral mode corresponds to an inbound link from another website.

4. The method of claim 1, wherein the referral mode corresponds to an inbound link from an Internet-based advertisement selected from the group consisting of a text advertisement, an image advertisement, a video advertisement and an audio advertisement.

5. The method of claim 1, wherein the referral mode corresponds to a geographic, demographic or temporal targeting of one or more Internet users.

6. The method of claim 1, wherein the referral mode is an action taken by one or more Internet users in association with content offered at the website.

7. The method of claim 2, further comprising:
using the value of the keyword to optimize a placement of the website in the organic or paid search results.

8. The method of claim 7, wherein the using comprises:
comparing the value of the keyword with a threshold value to reach a determination; and
modifying one or more parameters associated with the website in response to the determination in order to optimize the placement of the website in the search results.

9. The method of claim 8, wherein the one or more parameters include a paid search bid amount.

10. The method of claim 9, wherein the modifying includes decreasing, increasing or removing the paid search bid amount.

11. The method of claim 8, wherein the modifying includes adjusting a parameter of the website in response to the determination in order to optimize the placement of the website in a listing of organic search results.

12. The method of claim 8, wherein the one or more parameters include a use of the keyword within the website.

13. The method of claim 8, wherein the modifying includes replacing instances of the keyword within the website with instances of another keyword.

14. The method of claim 8, wherein the threshold value is a value of another keyword.

15. The method of claim 8, wherein the threshold value is a predefined value not derived from the keyword or another keyword.

16. The method of claim 8, wherein the threshold value is a value of the keyword with respect to another website.

17. The method of claim 8, wherein the value of the keyword pertains to a first paid search bid amount associated with the keyword and the threshold value pertains to a second paid search bid amount associated with the keyword.

18. The method of claim 1, further comprising:
achieving a predictive value of the referral mode.

19. The method of claim 1, wherein the value of the referral mode is represented in terms of a metric selected from the group consisting of a number of page views per visitor, a cost per page view, a cost per registration, a cost per download, a cost per video view, a total cost, a total amount of revenue, a total amount of margin, a return on advertising spent, an amount of margin per visitor, an amount of revenue per visitor, a cost per customer acquisition, a cost-per-click, and a click-through-rate.

20. The method of claim 1, wherein the analyzing includes:
weighting the data associated with the referral mode;
summing the weighted data to achieve a gross profit value of the referral mode; and
subtracting a cost associated with the referral mode to determine the value of the referral mode.

21. The method of claim 1, further comprising:
combining the value of the referral mode with a plurality of values associated with a plurality of referral modes so as to determine a group referral mode value.

22. The method of claim 1, wherein the acquired data includes a representation of web page views, a representation of web-based registrations, a representation of web-based purchases, a representation of web-based video views, and a representation of web-based downloads.

23. The method of claim 1, further comprising:
performing fraud analysis based on the data.

24. A system for determining a value of a referral mode relating to access of a website, comprising:
at least one processor;
a network interface;
a memory, operatively coupled to the processor, for storing logical instructions wherein execution of the logical instructions by the processor results in the performing of at least the following operations:
acquiring, via the network interface, data associated with the referral mode; and
analyzing the data to achieve a value of the referral mode with respect to the website.

25. The system of claim 24, wherein the referral mode is selected from the group consisting of a keyword associated with organic or paid search results at a search engine, an inbound link from another website, an inbound link from an Internet-based advertisement, a targeting of a first set of one or more Internet users, and an action taken by a second set of one or more Internet users in association with content offered at the website.

26. The system of claim 24, wherein the referral mode is a keyword associated with organic or paid search results at a search engine, the operations further comprising:
using the value of the keyword to optimize a placement of the website in the organic or paid search results.

27. The system of claim 26, wherein the using comprises:
comparing the value of the keyword with a threshold value to reach a determination; and
modifying one or more parameters associated with the website in response to the determination in order to optimize the placement of the website in the organic or paid search results.

28. The system of claim 27, wherein the threshold value is selected from the group consisting of a value of another keyword, a preconfigured value not derived from the keyword or another keyword, and a value of the keyword with respect to another website.

29. The system of claim 24, wherein the operations further comprise achieving a predictive value of the referral mode.

30. The system of claim 24, wherein the value of the referral mode is represented in terms of a metric selected from the group consisting of a number of page views per visitor, a cost per page view, a cost per registration, a cost per download, a cost per video view, a total cost, a total amount of revenue, a total amount of margin, a return on advertising spent, an amount of margin per visitor, an amount of revenue per visitor, a cost per customer acquisition, a cost-per-click, and a click-through-rate.

31. The system of claim 24, wherein the analyzing includes:
weighting the data associated with the referral mode;
summing the weighted data to achieve a gross profit value of the referral mode; and
subtracting a cost associated with the referral mode to determine the value of the referral mode.

32. The system of claim 24, wherein the acquired data includes a representation of web page views, a representation of web-based registrations, a representation of web-based purchases, a representation of web-based video views, and a representation of web-based downloads.

33. The system of claim 24, wherein the operations further comprise performing fraud analysis based on the data.
